(19) United States
(12) Patent Application Publication
(10) Pub. No.: US 2023/0286251 A1
(43) Pub. Date: Sep. 14, 2023

(54) A GLASS ROLL

(71) Applicant: CORNING INCORPORATED, CORNING, NY (US)

(72) Inventors: EuiHo Kim, Asan-si (KR); Junwoo Kim, Asan-si (KR); Sue Camille Lewis, Webster, NY (US); Ki Chul Suh, Suwon (KR)

(21) Appl. No.: 18/015,475

(22) PCT Filed: Jul. 12, 2021
(86) PCT No.: PCT/US2021/041262

§ 371 Date: Jan. 10, 2023

(30) Foreign Application Priority Data
Jul. 17, 2020 (KR) 10-2020-0089170

(51) Int. Cl. B32B 17/10; B32B 27/32; B32B 1/00; B32B 7/06; B65H 18/28

(52) U.S. Cl. CPC B32B 17/10; B32B 1/00; B32B 7/06; B32B 27/32; B65H 18/28; C03B 40/005

(57) ABSTRACT

A glass roll is provided. The glass roll includes a winding core having a central axis, a self adhesive film wound on the winding core about the central axis, and a glass ribbon wound on the self adhesive film about the central axis and attached onto the self adhesive film. In a cross-section of the glass roll that is parallel to the central axis and along an entire length of the glass roll, cross-sections of the self adhesive film may alternate with cross-sections of the glass ribbon.

### CROSS-REFERENCE TO RELATED APPLICATION

This application claims the benefit of priority under 35 U.S.C. § 371 of International Application No. PCT/US2021/041262, filed on Jul. 12, 2001, which claims the benefit of Korean Patent Application No. 10-2020-0089170, filed on Jul. 17, 2020, in the Korean Intellectual Property Office, the disclosure of each of which is incorporated herein in its entirety by reference.

### BACKGROUND

### 1. Field

The present disclosure relates to glass rolls. More particularly, the present disclosure relates to a glass roll including a glass ribbon and an interleaf both wound on a winding core.

### 2. Description of the Related Art

Glass having a small thickness is bendable and flexible. This bendable and flexible glass can be used as flexible displays, wearable electronic devices, and decorative materials for interior or exterior of buildings. This flexible glass may be wound on a roll and then may be stored, conveyed, and processed. Glass having a small thickness may be vulnerable to breakage during conveyance of glass in a roll-to-roll process, and the breakage of glass may cause the glass conveyance and the roll-to-roll process to stop. This may cause a down-time and huge loss of glass. Accordingly, there is a need to develop a carrier capable of continuing glass conveyance even when glass is slightly broken in a glass roll-to-roll process. On one hand, glass may be wound on a glass roll, together with an interleaf. In the conventional art, a polyethylene foam is used as an interleaf. However, for example, it may be difficult to remove air from the polyethylene foam in a vacuum-requiring process, such as a coating process. Accordingly, a stage of removing a polyethylene foam before a vacuum process may be required, and this requirement may cause increases in a process time and costs. Therefore, it is necessary to develop an interleaf compatible with a vacuum process.

### SUMMARY

The present disclosure provides a carrier capable of continuing glass conveyance even when glass is slightly broken in a glass roll-to-roll process, and an interleaf compatible with a vacuum process.

Additional aspects will be set forth in part in the description which follows and, in part, will be apparent from the description, or may be learned by practice of the presented embodiments of the present disclosure.

According to an aspect of the present disclosure, there is provided a glass roll including a winding core having a central axis, a self adhesive film wound on the winding core about the central axis, and a glass ribbon wound on the self adhesive film about the central axis and attached onto the self adhesive film. In a cross-section of the glass roll that is parallel to the central axis and along an entire length of the glass roll, cross-sections of the self adhesive film may alternate with cross-sections of the glass ribbon.

According to some embodiments, the glass ribbon may have a thickness of 0.05 mm to 0.3 mm.

According to some embodiments, a thickness of the self adhesive film may be less than a thickness of the glass ribbon.

According to some embodiments, a width of the self adhesive film in a direction parallel to the central axis may be 75% to 100% of a width of the glass ribbon in the direction parallel to the central axis.

According to an aspect of the present disclosure, a glass roll may include a winding core having an exterior surface, and a glass package including a self adhesive film having an upper surface and a lower surface opposite to each other, and a glass ribbon having a lower surface that adheres to the upper surface of the self adhesive film. The glass package may be wound on the winding core such that the lower surface of the self adhesive film faces the exterior surface of the winding core.

According to some embodiments, adhesion per unit area of the self adhesive film may be greater than 1.0 gf/cm² and less than 2.0 gf/cm².

According to some embodiments, a friction coefficient between the lower surface of the self adhesive film and the upper surface of the glass ribbon may be 0.05 to 3 when the friction coefficient was tested under a weight of 250 g.

According to an embodiment, the self adhesive film may include polyolefin.

According to some embodiments, the glass package may further include a leader film adhered to the upper surface of the self adhesive film and attached to a front end of the glass ribbon, and a trailer film adhered to the upper surface of the self adhesive film and attached to a back end of the glass ribbon.

According to some embodiments, only a portion of the leader film overlaps the self adhesive film when the glass package was unwound on a plane, and only a portion of the trailer film overlaps the self adhesive film when the glass package is unwound on a plane.

According to some embodiments, a length of the portion of the leader film overlapping the self adhesive film may be 30 cm to 100 cm, and a length of the portion of the leader film overlapping the self adhesive film may be 30 cm to 100 cm.

According to some embodiments, a friction coefficient between the upper surface of the glass ribbon and a lower surface of the leader film is 0.05 to 3 when the friction coefficient was tested under a weight of 250 g.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a plan view of a winding core and a glass package according to an embodiment of the present disclosure before a glass roll is formed;

FIG. 2 is a cross-sectional view illustrating cross-sections of the winding core and the glass package according to an embodiment of the present disclosure before a glass roll is formed, the cross-sections being parallel to a Y-Z plane;

FIG. 3 is a perspective view of a glass roll according to an embodiment of the present disclosure;

FIG. 4 is a cross-sectional view illustrating a cross-section of the glass roll that is parallel to a Y-Z plane, according to an embodiment of the present disclosure;

FIG. 5 is a cross-sectional view illustrating a cross-section of the glass roll that is parallel to a X-Y plane, according to an embodiment of the present disclosure.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Exemplary embodiments of the present disclosure will now be described more fully with reference to the accompanying drawings. The embodiments of the present disclosure may, however, be embodied in many different forms, and thus, the scope of the present disclosure should not be construed as limited to the exemplary embodiments set forth herein. Embodiments of the present disclosure should be interpreted as being provided to explain the present disclosure in more detail to one of ordinary skill in the art. Like numbers refer to like elements throughout the specification. Various elements and regions illustrated in the drawings are schematic in nature. Thus, the present disclosure is not limited to relative sizes or distances illustrated in the accompanying drawings.

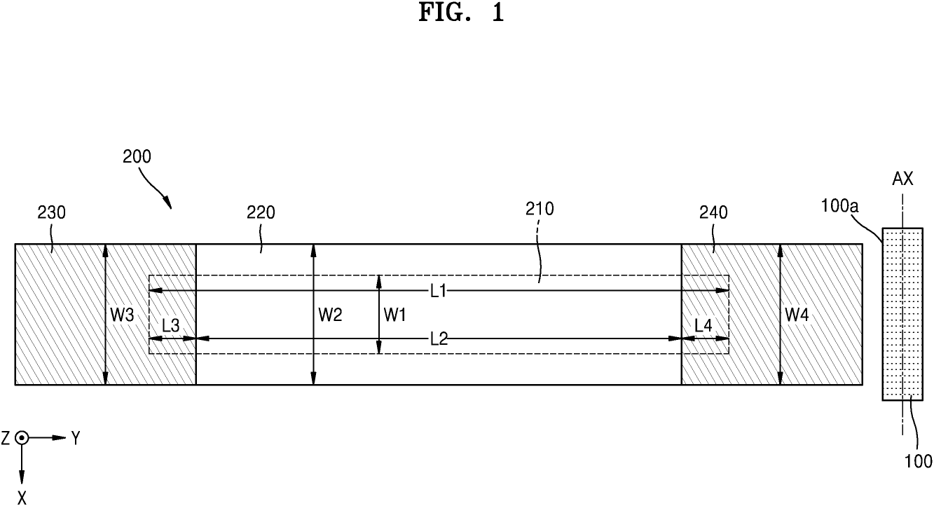

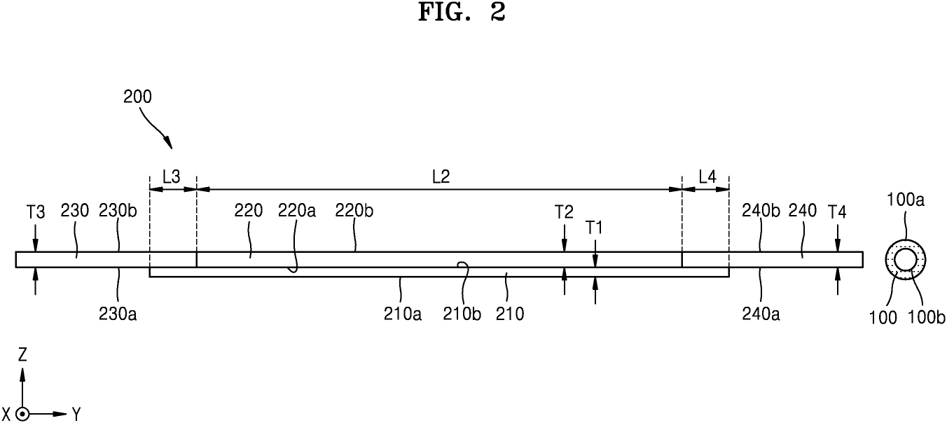

FIG. 1 is a plan view of a winding core 100 and a glass package 200 according to an embodiment of the present disclosure before a glass roll is formed. FIG. 2 is a cross-sectional view illustrating cross-sections of the winding core 100 and the glass package 200 according to an embodiment of the present disclosure before a glass roll is formed, the cross-sections being parallel to a Y-Z plane.

Referring to FIGS. 1 and 2, the winding core 100 may have an exterior surface 100a. According to some embodiments, the winding core 100 may have a cylindrical shape. When the winding core 100 has a hollow cylindrical shape, the winding core 100 may further have an interior surface 100b. However, the winding core 100 may have a filled cylindrical shape in contrast with FIG. 2. Due to a limitation of the flexibility of a glass ribbon 220, a diameter of the winding core 100 may be about 6 inches or greater.

The glass package 200 may include a self adhesive film 210, and the glass ribbon 220 on the self adhesive film 210. The self adhesive film 210 may have an upper surface 210b and a lower surface 210a opposite to each other. The upper surface 210b of the self adhesive film 210 may be an adhesive surface having adhesive properties, and the lower surface 210a of the self-adhesive film 210 may be a non-adhesive surface having no adhesive properties. The self adhesive film 210 may include, for example, polyolefin (PO), polyethylene (PE), polypropylene (PP), polyethylene terephthalate (PET), ethylene-vinyl acetate (EVA), polyamide (PA), or a combination thereof. The self adhesive film 210 may not be in a form of a foam, and may include little bubbles.

According to the present disclosure, the self adhesive film 210 may be used as a carrier for conveying the glass ribbon 220. Even when the glass ribbon 220 is slightly broken while being conveyed in a roll-to-roll process, pieces of the broken glass ribbon 220 may adhere to the self adhesive film 210 and conveyance of the glass ribbon 220 may continue. Accordingly, the possibility that the roll-to-roll process and conveyance of the glass ribbon 220 are interrupted due to breakage of the glass ribbon 220 may be reduced. The self adhesive film 210 as a carrier provides an appropriate frictional force to the surface of a conveyor to facilitate conveyance of the glass ribbon 220.

The glass ribbon 220 may have an upper surface 220b and a lower surface 220a opposite to each other. The lower surface 220a of the glass ribbon 220 may adhere to the upper surface 210b, namely, an adhesive surface 210b, of the self adhesive film 210. The glass ribbon 220 may include, for example, silicate glass, borosilicate glass, aluminosilicate glass, boro aluminosilicate glass, or a combination thereof, each containing or not containing alkali element(s). The glass ribbon 220 may be, for example, Willow® glass available from Corning Incorporated.

According to some embodiments, the glass package 200 may further include a leader film 230 adhering to the upper surface 210b of the self adhesive film 210 and attached to a front end of the glass ribbon 220. The leader film 230 may have an upper surface 230b and a lower surface 230a opposite to each other. The lower surface 230a of the leader film 230 may adhere to the upper surface 210b of the self adhesive film 210. According to some embodiments, the leader film 230 may include, for example, polyethylene (PE), polypropylene (PP), polyethylene terephthalate (PET), or a combination thereof. The leader film 230 may help the glass package 200 to be unwound without damage to the glass ribbon 220.

According to some embodiments, the glass package 200 may further include a trailer film 240 adhering to the upper surface 210b of the self adhesive film 210 and attached to a back end of the glass ribbon 220. The trailer film 240 may have an upper surface 240b and a lower surface 240a opposite to each other. The lower surface 240a of the trailer film 240 may adhere to the upper surface 210b of the self adhesive film 210. According to some embodiments, the trailer film 240 may include, for example, polyethylene (PE), polypropylene (PP), polyethylene terephthalate (PET), or a combination thereof. The trailer film 240 may help the glass package 200 to be wound on the winding core 100 without damage to the glass ribbon 220.

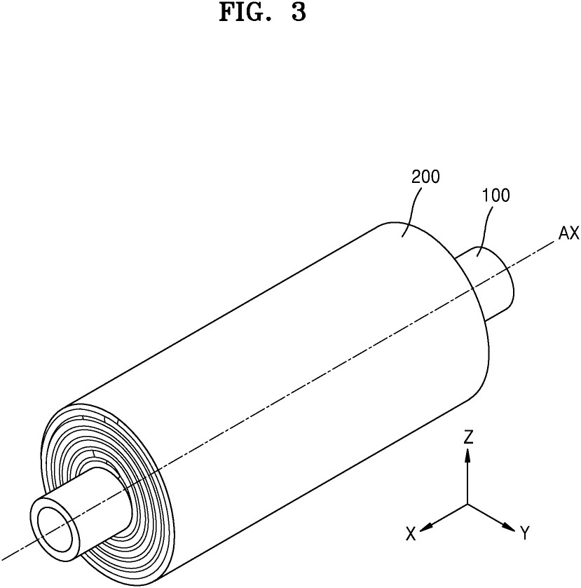

The glass package 200 may be wound on the winding core 100 such that the lower surface 210a of the self adhesive film 210 faces the exterior surface 100a of the winding core 100, thereby forming a glass roll 1000 of FIGS. 3 through 5 which will be described later.

According to some embodiments, a thickness T2 between the upper surface 220b and the lower surface 220a of the glass ribbon 220 may be about 0.05 mm to about 0.3 mm. When the thickness T2 of the glass ribbon 220 is less than about 0.05 mm, handling of the glass ribbon 220 is difficult, and thus it may be difficult to form a glass roll. When the thickness T2 of the glass ribbon 220 is greater than about 0.3 mm, the glass ribbon 220 is less flexible, and thus, it may be difficult to bend the glass ribbon 220 to form a glass roll.

According to some embodiments, a thickness T1 between the upper surface 210b and the lower surface 210a of the self adhesive film 210 may be less than the thickness T2 of the glass ribbon 220. When the thickness T1 of the self adhesive film 210 is less than the thickness T2 of the glass ribbon 220, a glass roll having a reduced volume compared with the conventional art may be realized, or more glass may be wound within a glass roll of the same volume. The thickness T1 of the self adhesive film 210 may be, for example, about 0.01 mm to about 0.25 mm. Because the thickness of a PE foam used as a conventional interleaf is significantly greater than the thickness T1 of the self adhesive film 210 and the thickness T2 of the glass ribbon 220, a glass roll having a very large volume may be realized, and less glass may be wound within a glass roll of the same volume. However, due to use of the self adhesive film 210, a glass roll having a reduced volume may be realized, or more glass may be wound within a glass roll of the same volume.

According to some embodiments, a thickness T3 between the upper surface 230b and the lower surface 230a of the leader film 230 and a thickness T4 between the upper surface 240b and the lower surface 240a of the trailer film 240 may be equal to the thickness T2 of the glass ribbon 220. According to other embodiments, the thickness T3 of the leader film 230 and the thickness T4 of the trailer film 240 may be greater than or less than the thickness T2 of the glass ribbon 220.

A width W2 of the glass ribbon 220 in a direction (X direction) parallel to a central axis AX of the winding core 100 may be, for example, about 50 mm to about 1300 mm. According to some embodiments, a width W1 of the self adhesive film 210 in the direction (X direction) parallel to the central axis AX of the winding core 100 may be 75% to 100% of the width W2 of the glass ribbon 220. When the width W1 of the self adhesive film 210 is less than 75% of the width W2 of the glass ribbon 220, an adhesive area between the self adhesive film 210 and the glass ribbon 220 may be relatively small, and thus, the adhesion between the self adhesive film 210 and the glass ribbon 220 may not be sufficiently large for conveyance of the glass ribbon 220 to continue even when the glass ribbon 220 is broken while being conveyed. When the width W1 of the self adhesive film 210 is greater than 100% of the width W2 of the glass ribbon 220, namely, when the width W1 of the self adhesive film 210 is greater than the width W2 of the glass ribbon 220, and the glass ribbon 220 needs to be handled in, for example, a coating process, a laminating process, a cleaning process, or a printing process, the glass ribbon 220 is not directly handled, and the glass ribbon 220 needs to be indirectly handled via the self adhesive film 210. Thus, it may be difficult to handle the glass ribbon 220.

According to some embodiments, the width W3 of the leader film 230 and the width W4 of the trailer film 240 in the direction (X direction) parallel to the central axis AX of the winding core 100 may be less than or equal to the width W2 of the glass ribbon 220. When the width W3 of the leader film 230 and the width W4 of the trailer film 240 is greater than the width W2 of the glass ribbon 220 and the glass ribbon 220 needs to be handled in, for example, a coating process, a laminating process, a cleaning process, or a printing process, the leader film 230 and the trailer film 240 may impede direct handling of the glass ribbon 220.

According to some embodiments, a length L2 of the glass ribbon 220 may be about 3 m to about 300 m. According to some embodiments, a length L1 of the self adhesive film 210 may be greater than the length L2 of the glass ribbon 220. Accordingly, when the glass package 200 is unwound on the X-Y plane, the self adhesive film 210 may be overlapped by the leader film 230 attached to the front end of the glass ribbon 220. Likewise, when the glass package 200 is unwound on the X-Y plane, the self adhesive film 210 may be overlapped by the trailer film 240 attached to the back end of the glass ribbon 220, from a planar view However, according to some embodiments, when the glass package 200 is unwound on the X-Y plane, the self adhesive film 210 may be overlapped by a portion of the leader film 230 and a portion of the trailer film 240. When the glass package 200 is unwound on the X-Y plane, the self adhesive film 210 may not be overlapped by a remaining portion of the leader film 230 and a remaining portion of the trailer film 240.

According to some embodiments, a length L3 by which the leader film 230 overlaps the adhesive film 210 and a length L4 by which the trailer film 240 overlaps the adhesive film 210 may be about 30 cm to about 100 cm, for example, about 30 cm to about 90 cm, about 30 cm to about 80 cm, about 30 cm to about 70 cm, about 30 cm to about 60 cm, about 30 cm to about 50 cm, about 30 cm to about 40 cm, about 40 cm to about 100 cm, about 50 cm to about 100 cm, about 60 cm to about 100 cm, about 70 cm to about 100 cm, about 80 cm to about 100 cm, about 90 cm to about 100 cm, about 30 cm to about 90 cm, about 40 cm to about 80 cm, or about 50 cm to about 70 cm. When the length L3 by which the leader film 230 overlaps the adhesive film 210 and the length L4 by which the trailer film 240 overlaps the adhesive film 210 are less than about 30 cm, an adhesive area between the leader film 230 and the adhesive film 210 and an adhesive area between the trailer film 240 and the adhesive film 210 may be too small to attain sufficient adhesion. Accordingly, when the glass package 200 is wound or unwound, the trailer film 240 or the leader film 230 may fall from the adhesive film 210 at an unwanted time point. When the length L3 by which the leader film 230 overlaps the adhesive film 210 and the length L4 by which the trailer film 240 overlaps the adhesive film 210 are greater than about 100 cm, adhesion between the leader film 230 and the adhesive film 210 and adhesion between the trailer film 240 and the adhesive film 210 may be too strong to detach the adhesive film 210 from the leader film 230 and the trailer film 240 at a wanted time point.

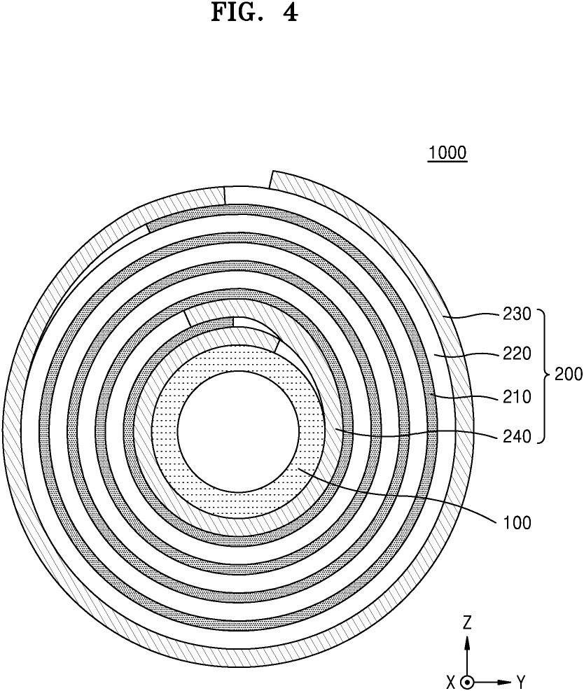

FIG. 3 is a perspective view of a glass roll 1000 according to an embodiment of the present disclosure. FIG. 4 is a cross-sectional view illustrating a cross-section of the glass roll 1000 that is parallel to a Y-Z plane, according to an embodiment of the present disclosure.

Referring to FIGS. 3 and 4, the glass roll 1000 may include the winding core 100, and the glass package 200 wound on the winding core 100. The winding core 100 may have the central axis AX. FIG. 4 illustrates a cross-section perpendicular to the central axis AX of the glass roll 1000. The glass package 200 may be wound about the central axis AX on the winding core 100. In more detail, the self adhesive film 210 is wound about the central axis AX on the winding core 100, and the glass ribbon 220 is wound about the central axis AX on the self adhesive film 210. According to some embodiments, the trailer film 240 may be wound about the central axis AX between the winding core 100 and the self adhesive film 210, and the leader film 230 may be wound about the central axis AX on the glass ribbon 220.

According to the present disclosure, the self adhesive film 210 may function as an interleaf and be wound together with the glass ribbon 220 around the winding core 100 to thereby form the glass roll 1000. Because the self adhesive film 210 is compatible with, for example, a vacuum process such as a coating process, the self adhesive film 210 does not need to be removed before the vacuum process. The self adhesive film 210 may be cheaper than a PE form used as an interleaf in the conventional art. Because the self adhesive film 210 may be thinner than the PE form used as an interleaf in the conventional art, the glass roll 1000 may have a reduced volume, or more glass ribbons 220 may be wound within the glass roll 1000 of the same volume.

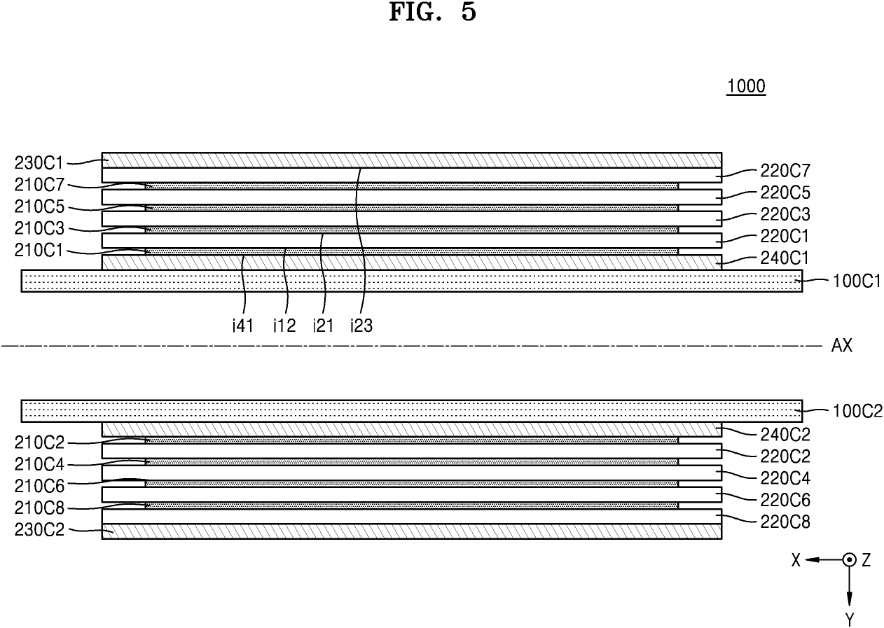

FIG. 5 is a cross-sectional view illustrating a cross-section of the glass roll 1000 that is parallel to the X-Y plane, according to an embodiment of the present disclosure. FIG. 5 illustrates a cross-section of the glass roll 1000 that is parallel to the central axis AX.

Referring to FIG. 5, in the cross-section of the glass roll 1000 that is parallel to the central axis AX, cross-sections 210C1, 210C3, 210C5, and 210C7 of a self adhesive film and cross-sections 220C1, 220C3, 220C5, and 220C7 of a glass ribbon may alternate with each other. In addition, Cross-sections 210C2, 210C4, 210C6, and 210C8 of the self adhesive film and cross-sections 220C2, 220C4, 220C6, and 220C8 of the glass ribbon may alternate with each other. According to some embodiments, first and second cross-sections 240C1 and 240C2 of a trailer film may be between first and second cross-sections 100C1 and 110C2 of a winding core and the cross-sections 220C1 and 220C2 of the glass ribbon, respectively. First and second cross-sections 230C1 and 230C2 of a leader film may be located on the cross-sections 220C7 and 220C8 of the glass ribbon, respectively. In other words, the first cross-section 240C1 of the trailer film, the cross-sections 210C1, 210C3, 210C5, and 210C7 of the self adhesive film and the cross-sections 220C1, 220C3, 220C5, and 220C7 of the self adhesive film alternating with each other, and the first cross-section 230C1 of the leader film may be stacked on the first cross-section 100C1 of the winding core, in a direction (-Y direction) perpendicular to the central axis AX of the winding core. Likewise, the second cross-section 240C2 of the trailer film, the cross-sections 210C2, 210C4, 210C6, and 210C8 of the self adhesive film and the cross-sections 220C2, 220C4, 220C6, and 220C8 of the self adhesive film alternating with each other, and the second cross-section 230C2 of the leader film may be stacked on the second cross-section 100C2 of the winding core, in a direction (Y direction) perpendicular to the central axis AX of the winding core.

An interface i41 between an upper surface of the trailer film (e.g., 240C1) and a lower surface of the self adhesive film (e.g., 210C1) may be a non-adhesive surface. According to some embodiments, a friction coefficient of the interface i41 between the upper surface of the trailer film (e.g., 240C1) and the lower surface of the self adhesive film (e.g., 210C1) may be 0.05 to 3, more preferably, 0.10 to 2.71 when the friction coefficient was tested under a weight of 250 g according to ASTM D 1894. When the friction coefficient of the interface i41 between the upper surface of the trailer film (e.g., 240C1) and the lower surface of the self adhesive film (e.g., 210C1) is less than 0.05, the self adhesive film (e.g., 210C1) may slide on the trailer film (e.g., 240C1) during conveyance of the glass roll 1000, and thus, the glass roll 1000 may be deformed. When the friction coefficient of the interface i41 between the upper surface of the trailer film (e.g., 240C1) and the lower surface of the self adhesive film (e.g., 210C1) is greater than 3, unwinding the glass package 200 may be difficult due to the large friction coefficient. For example, when the trailer film (e.g., 240C1) includes PET and the self adhesive film (e.g., 210C1) includes polyolefin, the friction coefficient of the interface i41 between the trailer film (e.g., 240C1) and the self adhesive film (e.g., 210C1) may be about 0.41 when the friction coefficient was tested under a weight of 250 g according to ASTM D 1894.

An interface i12 between an upper surface of the self adhesive film (e.g., 210C1) and a lower surface of the glass ribbon (e.g., 220C1) may be an adhesive surface. According to some embodiments, adhesion per unit area of the self adhesive film (e.g., 210C1) may be more than 1.0 gf/cm² and less than 2.0 gf/cm², for example, 1.1 gf/cm² to 1.9 gf/cm², 1.1 gf/cm² to 1.8 gf/cm², 1.1 gf/cm² to 1.7 gf/cm², 1.1 gf/cm² to 1.6 gf/cm², 1.1 gf/cm² to 1.5 gf/cm², 1.1 gf/cm² to 1.4 gf/cm², 1.1 gf/cm² to 1.3 gf/cm², 1.1 gf/cm² to 1.2 gf/cm², 1.2 gf/cm² to 1.9 gf/cm², 1.3 gf/cm² to 1.9 gf/cm², 1.4 gf/cm² to 1.9 gf/cm², 1.5 gf/cm² to 1.9 gf/cm², 1.6 gf/cm² to 1.9 gf/cm², 1.7 gf/cm² to 1.9 gf/cm², 1.8 gf/cm² to 1.9 gf/cm², 1.2 gf/cm² to 1.8 gf/cm², 1.3 gf/cm² to 1.7 gf/cm², or 1.4 gf/cm² to 1.6 gf/cm². When the adhesion per unit area of the self adhesive film (e.g., 210C1) is 1.0 gf/cm² or less, the adhesion is not sufficiently large so that glass may not be able to be continuously conveyed when glass is broken while being conveyed in a roll-to-roll process. When the adhesion per unit area of the self adhesive film (e.g., 210C1) is 2.0 gf/cm² or greater, it may be difficult for a user of the glass roll 1000 to remove the self adhesive film (e.g., 210C1) from the glass ribbon (e.g., 220C1). For example, the self adhesive film (e.g., 210C1) includes polyolefin, the adhesion per unit area of the self adhesive film (e.g., 210C1) may be about 1.1 gf/cm².

An interface i21 between an upper surface of the glass ribbon (e.g., 220C1) and a lower surface of the self adhesive film (e.g., 210C3) may be a non-adhesive surface. According to some embodiments, a friction coefficient of the interface i21 between the upper surface of the glass ribbon (e.g., 220C1) and the lower surface of the self adhesive film (e.g., 210C3) may be 0.05 to 3, more preferably, 0.1 to 2.71, for example, 0.1 to 2.6, 0.1 to 2.4, 0.1 to 2.2, 0.1 to 2.0, 0.1 to 1.8, 0.1 to 1.6, 0.1 to 1.4, 0.1 to 1.2, 0.1 to 1.0, 0.1 to 0.8, 0.1 to 0.6, 0.1 to 0.4, 0.1 to 0.2, 0.2 to 2.7, 0.4 to 2.7, 0.6 to 2.7, 0.8 to 2.7, 1 to 2.7, 1.2 to 2.7, 1.4 to 2.7, 1.6 to 2.7, 1.8 to 2.7, 2 to 2.7, 2.2 to 2.7, 2.4 to 2.7, 2.6 to 2.7, 0.2 to 2.6, 0.4 to 2.4, 0.6 to 2.2, 0.8 to 2, 1 to 1.8, or 1.2 to 1.6 when the friction coefficient was tested under a weight of 250 g according to ASTM D 1894. When the friction coefficient of the interface i21 between the upper surface of the glass ribbon (e.g., 220C1) and the lower surface of the self adhesive film (e.g., 210C3) is less than 0.05, the self adhesive film (e.g., 210C3) may slide on the glass ribbon (e.g., 220C1) during conveyance of the glass roll 1000, and thus, the glass roll 1000 may be deformed. When the friction coefficient of the interface i21 between the upper surface of the glass ribbon (e.g., 220C1) and the lower surface of the self adhesive film (e.g., 210C3) is greater than 3, unwinding the glass package 200 may be difficult due to the large friction coefficient. For example, when the glass ribbon (e.g., 220C1) includes Corning ® Willow® glass and the self adhesive film (e.g., 210C3) includes polyolefin, the friction coefficient of the interface i21 between the glass ribbon (e.g., 220C1) and the self adhesive film (e.g., 210C3) may be about 0.30 when the friction coefficient was tested under a weight of 250 g according to ASTM D 1894.

An interface i23 between an upper surface of the glass ribbon (e.g., 220C7) and a lower surface of the leader film (e.g., 230C1) may be a non-adhesive surface. According to some embodiments, the friction coefficient of the interface i23 between the upper surface of the glass ribbon (e.g., 220C7) and the lower surface of the leader film (e.g., 230C1) may be 0.05 to 3, more preferably, 0.1 to 2.71 when the friction coefficient was tested under a weight of 250 g according to ASTM D 1894. When the friction coefficient of the interface i23 between the upper surface of the glass ribbon (e.g., 220C7) and the lower surface of the leader film (e.g., 230C1) is less than 0.05, the leader film (e.g., 230C1) may slide on the glass ribbon (e.g., 220C7) during conveyance of the glass roll 1000, and thus, the glass roll 1000 may be deformed. When the friction coefficient of the interface i23 between the upper surface of the glass ribbon (e.g., 220C7) and the lower surface of the leader film (e.g., 230C1) is greater than 3, unwinding the glass package 200 may be difficult due to the large friction coefficient. For example, when the leader film (e.g., 230C1) includes PET and the glass ribbon (e.g., 220C7) includes Corning ® Willow® glass, the friction coefficient of the interface i23 between the upper surface of the glass ribbon (e.g., 220C7) and the lower surface of the leader film (e.g., 230C1) may be about 0.37 when the friction coefficient was tested under a weight of 250 g according to ASTM D 1894.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A glass roll comprising:
a winding core having a central axis;
a self adhesive film wound on the winding core about the central axis; and
a glass ribbon wound on the self adhesive film about the central axis and attached onto the self adhesive film,
wherein, in a cross-section of the glass roll that is parallel to the central axis and along an entire length of the glass roll, cross-sections of the self adhesive film alternate with cross-sections of the glass ribbon.

2. The glass roll of claim 1, wherein a thickness of the glass ribbon is 0.05 mm to 0.3 mm.

3. The glass roll of claim 1, wherein a thickness of the self adhesive film is less than a thickness of the glass ribbon.

4. The glass roll of claim 1, wherein a width of the self adhesive film in a direction parallel to the central axis is 75% to 100% of a width of the glass ribbon in the direction parallel to the central axis.

5. A glass roll comprising:
a winding core having an exterior surface; and
a glass package including a self adhesive film having an upper surface and a lower surface opposite to each other and a glass ribbon having a lower surface that adheres to the upper surface of the self adhesive film,
wherein the glass package is wound on the winding core such that the lower surface of the self adhesive film faces the exterior surface of the winding core.

6. The glass roll of claim 5, wherein adhesion per unit area of the self adhesive film is greater than 1.0 gf/cm² and less than 2.0 gf/cm².

7. The glass roll of claim 5, wherein a friction coefficient between the lower surface of the self adhesive film and an upper surface of the glass ribbon is 0.05 to 3 when the friction coefficient was tested under a weight of 250 g.

8. The glass roll of claim 5, wherein the self adhesive film comprises polyolefine.

9. The glass roll of claim 5, wherein the glass package further comprises:
a leader film adhered to the upper surface of the self adhesive film and attached to a front end of the glass ribbon; and
a trailer film adhered to the upper surface of the self adhesive film and attached to a back end of the glass ribbon.

10. The glass roll of claim 9, wherein only a portion of the leader film overlaps the self adhesive film when the glass package was unwound on a plane, and only a portion of the trailer film overlaps the self adhesive film when the glass package was unwound on a plane.

11. The glass roll of claim 10, wherein a length of the portion of the leader film overlapping the self adhesive film is 30 cm to 100 cm, and a length of the portion of the trailer film overlapping the self adhesive film is 30 cm to 100 cm.

12. The glass roll of claim 9, wherein a friction coefficient between the upper surface of the glass ribbon and a lower surface of the leader film is 0.05 to 3 when the friction coefficient was tested under a weight of 250 g.
